(19) United States
(12) Patent Application Publication
(10) Pub. No.: US 2008/0310532 A1
(43) Pub. Date: Dec. 18, 2008

(54) Method for Signal Reception

(75) Inventors: Constant Paul Marie Jozef Baggen, Eindhoven (NL); Alessio Filippi, Eindhoven (NL); Sri Andari Husen, Eindhoven (NL); Maurice Leonardus Anna Stassen, Eindhoven (NL); Volker Aue, Dresden (DE); Andreas Bury, Dresden (DE); Thomas Fliess, Dresden (DE); Yann Casamajou, Argences (FR); Frederic Pirot, Argences (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V, Eindhoven (NL)

(21) Appl. No.: 12/097,773

(22) PCT Filed: Dec. 14, 2006
(86) PCT No.: PCT/IB06/54842

§ 371 Date: Jun. 17, 2008

(30) Foreign Application Priority Data
Dec. 20, 2005 (EP) 05112436.0

(51) Int. Cl. H04L 27/28

(52) U.S. Cl. 375/260

(57) ABSTRACT

In an OFDM mobile communications system, an algorithm for forming a preliminary estimate of the channel on pilot subcarriers is carried out. Based on this preliminary estimate, a channel property is estimated. This channel property is then used to decide whether to enter a mobile receiver mode or a stationary receiver mode. For example, in the mobile mode channel estimation is performed using only pilot symbols from the current symbol period, while in the static mode channel estimation is performed using pilot symbols from the current symbol period and pilot symbols from other symbol periods.

The present invention relates to a method of processing OFDM encoded digital signals in a communication system, and a corresponding signal processor.

The invention also relates to a receiver arranged to receive OFDM encoded signals and to a mobile device that is arranged to receive OFDM encoded signals. Finally, the invention relates to a telecommunication system comprising such a mobile device.

The method may be used for deriving improved channel estimation, and hence improved data estimation, in a system using OFDM modulation with pilot subcarriers, such as the terrestrial video broadcasting systems DVB-T or DVB-H. The mobile device according to the invention can for example be a portable TV receiver, a mobile phone, a personal digital assistant (PDA), or a portable computer such as a laptop, or any combination thereof.

In an OFDM communication system, the data to be transmitted is modulated onto a number of subcarrier signals having different frequencies. The receiver then has to demodulate the transmitted data from these subcarrier signals. The received signals are affected by the properties of the wireless channel from the transmitter to the receiver and so, in order to be able to perform this demodulation, the receiver has to use an estimate of the properties of the channel.

The channel can vary with time, and so the channel estimation needs to be performed at regular intervals. Moreover, the channel can vary between the different subcarrier frequencies of the transmitted signal. Based on an estimate of the channel on a subset of the subcarriers, and an estimate of the channel frequency response, it is possible to make an estimate of the channel on the other subcarriers.

U.S. Pat. No. 6,654,429 discloses a method for pilot-aided channel estimation, in which pilot symbols (that is, symbols having known values) are inserted into each transmitted data packet at known positions so as to occupy predetermined positions in the time-frequency space. That is, at particular times, pilot symbols may be transmitted at some of the subcarrier frequencies. At other times, pilot symbols may be transmitted at others of the subcarrier frequencies. By examining the symbols received at those times and frequencies at which pilot symbols were transmitted, it is possible to estimate the channel transfer function, at those times and frequencies, accurately enough to be useful.

Depending on the properties of the channel, it is possible also to estimate the channel transfer function at those times and frequencies at which useful data was transmitted.

In order to be able to improve as far as possible the channel estimation, without increasing excessively the number of transmitted pilot symbols, it is known to perform the channel estimation during a particular time period, based on the pilot symbols transmitted at that time, and during previous and following time periods.

However, this technique is not suitable for use in an OFDM receiver within a mobile device, because, particularly if the mobile device is moving at relatively high speeds, the channel transfer function may be varying relatively quickly, with the result that the pilot symbols transmitted during previous time periods and following are of less use in performing the required channel estimation, and so the channel estimator does not have sufficient information to make a reliable channel estimate, at least using those channel estimation algorithms that assume that the channel is effectively stationary.

An object of the present invention is to provide a method of processing OFDM encoded digital signals, which produces useful results both when the receiver is moving and when the receiver is stationary.

According to a first aspect of the present invention, there is provided a method of processing OFDM encoded digital signals, wherein said OFDM encoded digital signals are transmitted as data symbol subcarriers in a plurality of frequency channels, and a subset of said subcarriers are pilot subcarriers, the method comprising: receiving an OFDM encoded signal over a wireless channel; forming an estimate of the wireless channel, based on received pilot subcarriers; determining whether properties of the estimated wireless channel are indicative of a relatively high rate of change of the wireless channel or a relatively low rate of change of the wireless channel; and processing the received signal based on the properties of the estimated wireless channel.

This has the advantage that the signal processing can be performed in a way which takes account of any movement of the receiver.

Preferably, if the properties of the estimated wireless channel are indicative of a relatively high rate of change of the wireless channel, an estimate of a frequency response of the wireless channel is formed based on a first channel estimation algorithm, and if the properties of the estimated wireless channel are indicative of a relatively low rate of change of the wireless channel, an estimate of a frequency response of the wireless channel is formed based on a second channel estimation algorithm.

This has the advantage that the channel estimation can be performed in a way which takes account of any movement of the receiver.

According to a second aspect of the present invention, there is provided a receiver, for use in an OFDM communications system, wherein OFDM encoded digital signals are transmitted over a wireless channel as data symbol subcarriers in a plurality of frequency channels, and a subset of said subcarriers are pilot subcarriers, wherein the receiver comprises a processor for: forming an estimate of the wireless channel, based on received pilot subcarriers; determining whether properties of the estimated wireless channel are indicative of a relatively high rate of change of the wireless channel or a relatively low rate of change of the wireless channel; and processing the received signal based on the properties of the estimated wireless channel.

Further objects, features and advantages of the invention will become evident from a reading of the following description, in which reference will now be made, by way of example only, to the accompanying drawings, in which:

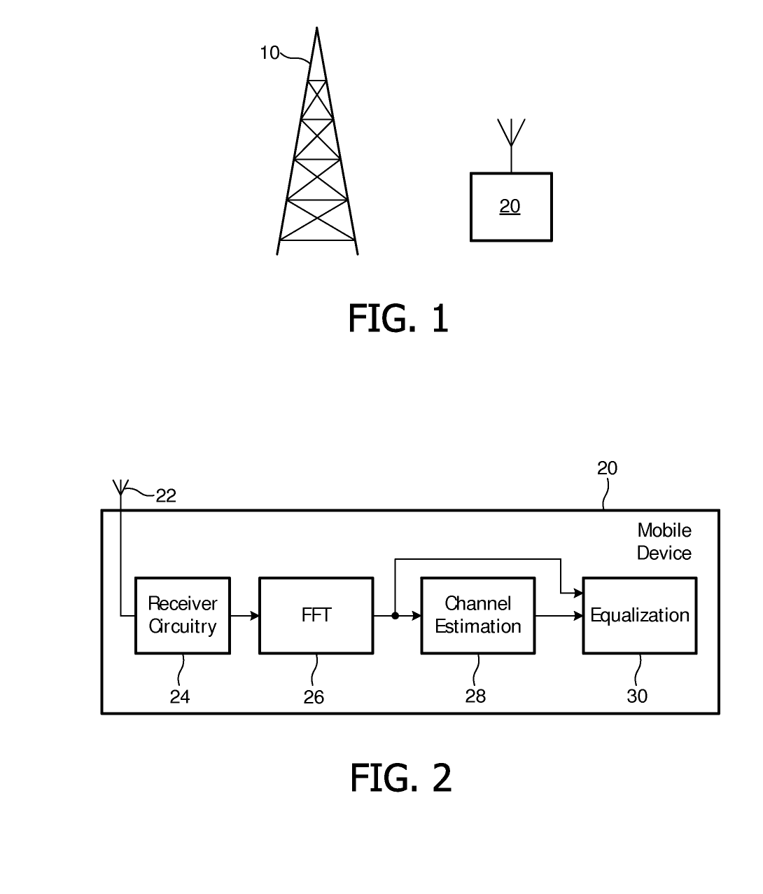

FIG. 1 is a schematic illustration of a communications system in accordance with the invention;

FIG. 2 is a block schematic diagram of a mobile communications device in accordance with an aspect of the invention;

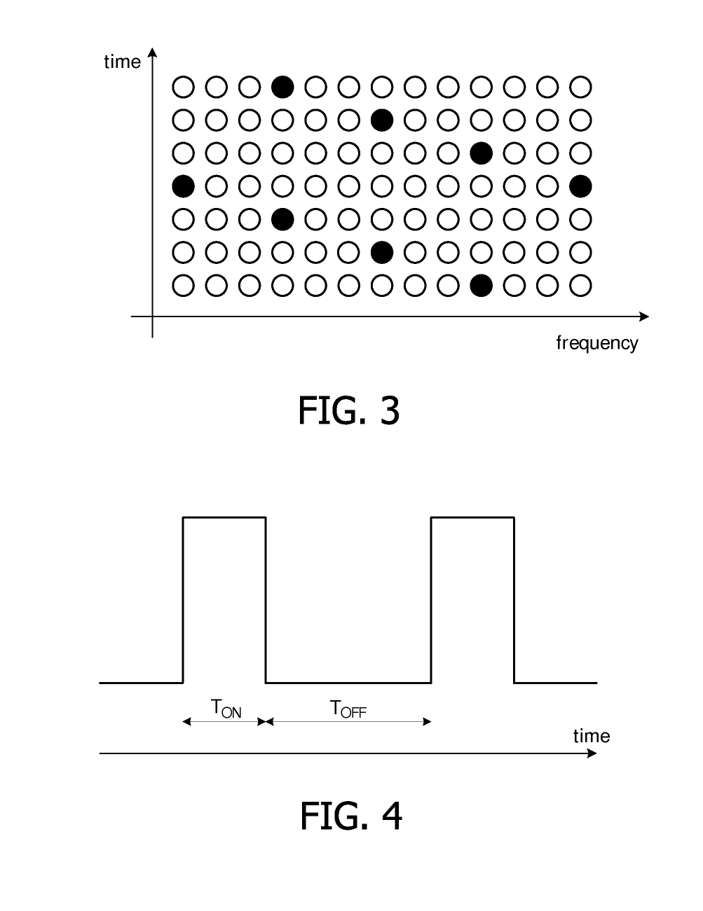

FIG. 3 illustrates the transmission of pilot symbols amongst the useful data in an OFDM communications system;

FIG. 4 illustrates an aspect of the operation of a mobile communications device in accordance with an aspect of the invention;

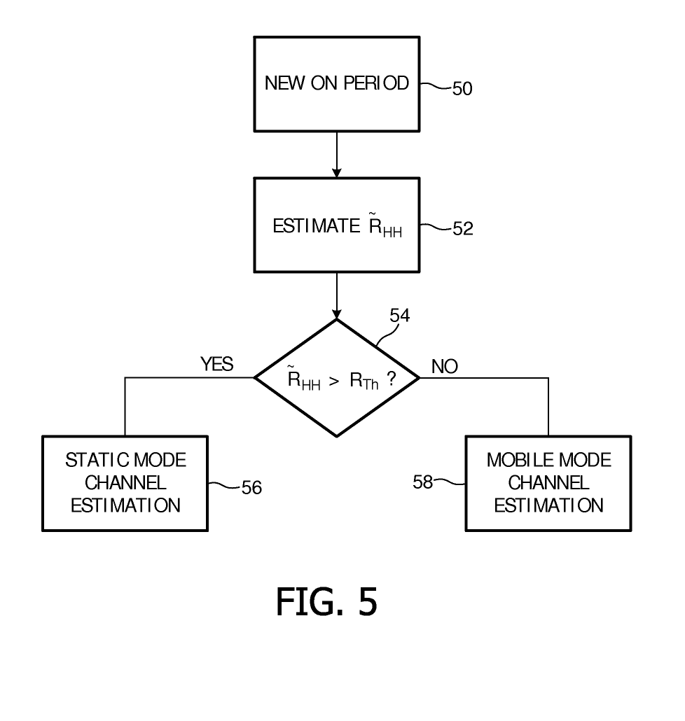

FIG. 5 is a flow chart illustrating a method in accordance with an aspect of the invention;

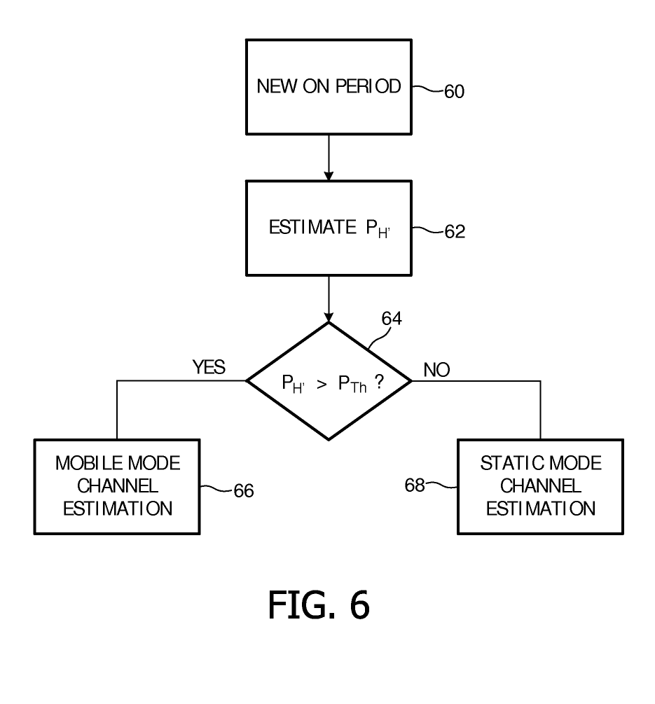

FIG. 6 is a flow chart illustrating a method in accordance with an alternative aspect of the invention.

The present invention will be described with reference to a communication system as shown in FIG. 1, in which DVB-T (Digital Video Broadcasting-Terrestrial) or DVB-H (Digital Video Broadcasting-Handheld) signals are broadcast from a transmitter 10. FIG. 1 shows a single receiver 20, which is able to receive the broadcast signals, although it will be appreciated that, in a practical system, there can be expected to be a large number of such receivers that are able to receive the broadcast signals.

The present invention will be further described with reference to a communication system as shown in FIG. 1, in which the receiver 20 is a portable device that is able to receive the broadcast signals while moving in the area around the transmitter 10.

As is known, the DVB-H system is an Orthogonal Frequency Division Multiplexed (OFDM) communication system, in which the data to be transmitted is modulated onto a number of subcarrier signals having different frequencies. The receiver then has to demodulate the transmitted data from these subcarrier signals. The received signals are affected by the properties of the wireless channel from the transmitter to the receiver and so, in order to be able to perform this demodulation, the receiver has to use an estimate of the properties of the channel.

FIG. 2 is a block schematic diagram illustrating in more detail those components of the receiver 20 that are relevant for an understanding of the present invention. It will of course be appreciated that the receiver 20 has many other features and components, which are not shown in FIG. 2 and will not be described in more detail herein.

As described above, the receiver 20 takes the form of a mobile device, which can for example be a portable TV receiver, a mobile phone, a personal digital assistant (PDA), or a portable computer such as a laptop, or any combination thereof.

The mobile device 20 has an antenna 22 for receiving signals, and receiver circuitry 24 for amplifying the received signals and converting them into a useable form. The received signals are then passed to a Fast Fourier Transform (FFT) block 26, which separates out the symbols received by the receiver in the different subcarriers in use. As will be appreciated by the person skilled in the art, the received OFDM symbol Y (Y being an N×1 vector, where N is the number of subcarriers or the FFT size) will show the effects of the channel on the transmitted symbols A (A also being an N×1 vector), and will contain added noise W. That is:

Y=H·A+W

where H is a N×N matrix representing the channel frequency response.

If the channel is time-invariant, then the matrix H only has non-zero elements on its main diagonal. If the channel is time-variant during one symbol period, then its time variation is represented by non-zero elements off the main diagonal of the channel matrix H. Since the channel is changing, the channel matrix changes from one symbol period to the next. In the following, the channel matrix H will be referred to as H(t,f), to underline that it varies in time and frequency.

In order to be able to determine the values of the transmitted symbols from the received symbols, it is therefore necessary to use a value for H(t,f), the time varying channel frequency response. The received symbols are therefore passed to a channel estimation block 28, which forms a channel estimate.

The received symbols, and the channel estimate formed by the channel estimation block 28, are also passed to an equalization block 30, which forms an estimate of the transmitted symbols from the received symbols, and the value for H(t,f), the time varying channel frequency response.

In order to allow the channel estimation block 28 to make an acceptably accurate estimate of the channel, pilot symbols, that is, symbols having known values, are included in the signals transmitted from the transmitter 10.

FIG. 3 is a schematic representation of the time-frequency plane in the DVB-H and DVB-T OFDM communication systems. That is, circles at different vertical positions in the plane shown in FIG. 3 represent symbols transmitted at different times, while circles at different horizontal positions in the plane shown in FIG. 3 represent symbols transmitted at different subcarrier frequencies.

In FIG. 3, the solid black circles represent the pilot symbols broadcast from the transmitter 20, while the empty circles represent the data subcarriers broadcast from the transmitter 20.

Thus, in this illustrated example, during any one symbol period, one subcarrier in twelve contains a pilot symbol. Put another way, one subcarrier in three contains a pilot symbol during one symbol period in four, while the other two subcarriers are not used to contain pilot symbols. Assuming that the frequency dependent effect of the time varying channel for a subcarrier of interest during a particular symbol period is sufficiently similar to the effect of the time varying channel for one or more of the subcarriers containing pilot symbols, then it is possible to determine an acceptable estimate of the channel for that subcarrier of interest. As will be discussed in more detail below, it may or may not be possible to use subcarriers containing pilot symbols from different symbol periods, depending on whether or not the receiver is moving at the time.

In order to save power, which is a major consideration in handheld devices, it is proposed to implement a power saving routine in DVB-H receivers. FIG. 4 illustrates this power saving routine. Specifically, it is proposed that the receiver should receive data for a given period of time T_{ON} and then shut down for a time period T_{OFF}, and then repeat this cycle.

In one embodiment of the invention, it is determined once in each cycle how to determined which channel estimation procedure to use. However, it will be appreciated that this determination may be made more frequently or less frequently, and that the invention may also be used in systems that do not utilize this power saving routine, in which case the determination may be made at any convenient time, for example at fixed times.

FIG. 5 is a flow chart illustrating a method in accordance with the present invention. In step 50, it is determined that the receiver is entering a new data receiving period T_{ON} as shown in FIG. 4. An algorithm for estimating the channel on the pilot subcarriers is then carried out. Based on this preliminary estimate, which may first be improved using known techniques, a channel property is estimated. This channel property is then used to decide which method of channel estimation should be used.

Specifically, in step 52, an estimate of the time correlation of the channel frequency response, \tilde{R}_{HH}, is made. Then, in step 54 of the process, this estimate of the time correlation is compared with a threshold value R_{Th}.

If the estimate exceeds the threshold, it is determined that the properties of the wireless channel are not indicative of a relatively high rate of change of the channel, which suggests that the device may be stationary or moving acceptably slowly, and the process passes to step 56, in which a static mode channel estimation is performed. On the other hand, if the estimate does not exceed the threshold, it is determined that the properties of the wireless channel are indicative of a relatively high rate of change of the channel, which suggests that the device may be moving, and the process passes to step 58, in which a mobile mode channel estimation is performed.

The invention proceeds from the realization that a conventional channel estimation procedure, for use in an OFDM system using pilot symbols distributed in the time-frequency space, as shown in FIG. 3, will not work well in a mobile receiver in which the channel may be varying relatively quickly, because such procedures use pilot symbols from different symbol periods. The channel estimates obtained using pilot symbols from symbol periods other than the current symbol period may not be acceptably accurate for estimating the channel in the current symbol period.

On the other hand, although alternative channel estimation procedures are known, for use when the receiver is moving, such channel estimation procedures will not work well when the channel is characterized by the presence of long echoes, as may for example be the case in single frequency networks (SFNs).

Thus, in step 56, in which the static mode channel estimation is performed, the channel is estimated using pilot symbols from the current symbol period and using pilot symbols from other symbol periods. Suitable methods are well known to the person skilled in the art, for example from the document “Two-dimensional pilot-symbol-aided channel estimation by Wiener filtering”, P. Hoeher, S. Kaiser, P. Robertson in Proc. IEEE ICASSP '97, Munich Germany, pp. 1845-1848, April 1997.

Further, in step 58, in which the mobile mode channel estimation is performed, the channel is estimated using only pilot symbols from the current symbol period. Suitable methods are well known to the person skilled in the art, for example from the document “Combatting Doppler Broadening for DVB-T”, S. Baggen, S. A. Husen, M. Stassen, H. Y. Tsang, 4th Asia Europe Workshop on Information Theory Concepts (AEW4), Viareggio, Italy, October 2004.

In steps 52 and 54, therefore, an estimate of the time correlation of the channel frequency response, \tilde{R}_{HH}, is made, and this is compared with a threshold value R_{Th}, in such a way as to attempt to identify cases where the conventional channel estimation procedure would not be expected to work well, and the alternative channel estimation procedures may produce better results. Although in this illustrated embodiment of the invention, an estimate of the time correlation of the channel frequency response is compared with a threshold value, other decision variables may be used to identify such cases.

In this illustrated embodiment of the invention, the time correlation of the channel frequency response is determined by examining the correlation between the estimates of the channel, as they apply to two successive pilot symbols on one of the subcarriers. Since, on the subcarriers that are used to contain pilot symbols, the pilot symbols are spaced apart by the duration of four OFDM symbol periods, 4.T_{OFDM}, this correlation is referred to as R_{HH|H}(4T_{OFDM}), where

R_{HH|H}(4T_{OFDM})=E[Hₘ(t+4T_{OFDM})H*ₘ(t)],

where H*ₘ(t) is the complex conjugate of the channel at time t, while Hₘ(t+4T_{OFDM}) represents the channel at time (t+4.T_{OFDM}).

It should also be noted that the value of the correlation determined in this way is also influenced by the current overall fading. If the average received energy of the signals is low, then the estimation of R_{HH|H}(4T_{OFDM}) is also reduced. To avoid this resulting in an inaccurate determination that the device is moving, in a case where the value of the correlation has a low value only because the received signals have low energy, it is proposed to normalize the value of the correlation determined in this way with respect to R_{HH|H}(0). The decision variable R̅_{HH} becomes

\tilde{R}_{HH}=R_{HH|H}(4T_{OFDM})/R_{HH|H}(0).

In the following illustrated embodiment, the normalized correlation \hat{R}_{HH|H} is measured over eight OFDM symbols, using the estimated channel transfer factors on the pilot symbol positions Ĥ_{q}(k), q=0 . . . N_{P}−1 and k=0 . . . K−1, see FIG. 3. The number N_{P} is the number of pilot symbols in a single OFDM symbol. For the 8K OFDM mode of the DVB-H and DVB-T standards, N_{P}=589. The number K is the number of consecutive OFDM symbols used in the estimation. As mentioned above, in this illustrated case K=8. The estimate energy reads as

$${\hat{R}}_{HH \vert H} ( 0 ) = \frac{1}{KP} {\sum }_{k = 0}^{K - 1} {\sum }_{p = 0}^{{N}_{P} - 1} {\vert {\hat{H}}_{p} ( k ) \vert}^{2} .$$

We assume that K is even, then the estimation of the correlation is given by

$${\hat{R}}_{HH \vert H} ( 4 {T}_{OFDM} ) = Re \{ \frac{2}{KP} {\sum }_{k = 0}^{K / 2 - 1} {\sum }_{p = 0}^{{N}_{P} - 1} {\hat{H}}_{p}^{*} ( k ) {H}_{p} ( k + 4 ) \} .$$

As mentioned above, the measured variable which is compared with the threshold is

\tilde{R}_{HH}=\hat{R}_{HH|H}(4T_{OFDM})/\hat{R}_{HH|H}(0).

It should also be noted that multiple values for the estimate of the correlation can be formed, and then the average of those values can be compared with the threshold value.

FIG. 6 is a flow chart illustrating an alternative method in accordance with the present invention. In step 60, it is determined that the receiver is entering a new ON period T_{ON} as shown in FIG. 4. An algorithm for estimating the channel in the pilot positions is then carried out. Based on this preliminary estimate, which may first be improved using known techniques, a channel property is estimated. This channel property is then used to decide which method of channel estimation should be used.

Specifically, in step 62, an estimate of the power of the time derivative of the channel, P_{H′}, is made. Then, in step 64 of the process, this estimate of the time correlation is compared with a threshold value P_{Th}.

If the estimate exceeds the threshold, the process passes to step 66, in which a mobile mode channel estimation is performed. On the other hand, if the estimate does not exceed the threshold, the process passes to step 68, in which a static mode channel estimation is performed.

In step 66, in which the mobile mode channel estimation is performed, the channel is estimated using only pilot symbols from the current symbol period. Suitable methods are well known to the person skilled in the art, for example from “Combatting Doppler Broadening for DVB-T”, S. Baggen, S. A. Husen, M. Stassen, H. Y. Tsang, 4th Asia Europe Workshop on Information Theory Concepts (AEW4), Viareggio, Italy, October 2004.

In step 68, in which the static mode channel estimation is performed, the channel is estimated using pilot symbols from the current symbol period and pilot symbols from other symbol periods. Suitable methods are well known to the person skilled in the art, for example from “Two-dimensional pilot-symbol-aided channel estimation by Wiener filtering”, P. Hoeher, S. Kaiser, P. Robertson in Proc. IEEE ICASSP '97, Munich Germany, pp. 1845-1848, April 1997.

As mentioned above, in step 62, an estimate of the power of the time derivative of the channel, P_{H′}, is made. Preferably, the estimate that is used is the result of averaging multiple estimates of the power of the time derivative of the channel. In the preferred embodiment of the invention, a value of the power of the time derivative is estimated once in every 400 symbol periods. In a situation where the symbol period T_{OFDM} is equal to 1 millisecond, and when T_{ON}=2 seconds (although in practice T_{ON} could be within at least the range from 0.3 seconds to 125 seconds), this allows five estimates to be obtained within one symbol period. This is sufficient to allow an acceptable estimate to be made. The averaging process is only valuable if the estimates being averaged are independent of each other, for which purpose they need to be spaced apart sufficiently. That is, estimates that are made within the channel coherence time T_{C} of a preceding estimate are not useful for this purpose, where the channel coherence time T_{C} is the reciprocal of the maximum Doppler frequency f_{D,max}, which is a measure of the speed at which the receiver is moving.

There is therefore described a method for determining whether or not properties of the estimated wireless channel are indicative of a relatively high rate of change of the wireless channel, and using an appropriate method for channel estimation in either case. In other embodiments of the invention, it can again be determined whether properties of the estimated wireless channel are indicative of a relatively high rate of change of the wireless channel or a relatively low rate of change, and other receiver algorithms for use in mobile reception can be used or not, as appropriate. For example, in the case of mobile reception, algorithms are known for inter-carrier interference (ICI) cancellation. Where the initial estimate of the properties of the wireless channel are indicative of a relatively high rate of change of the wireless channel, the receiver can enter a “mobile mode”, in which these ICI cancellation algorithms are used, whereas, when the initial estimate of the properties of the wireless channel are indicative of a relatively low rate of change of the wireless channel, the receiver can enter a “stationary mode”, in which these ICI cancellation algorithms are not used.

1. A method of processing OFDM encoded digital signals, wherein said OFDM encoded digital signals are transmitted as data symbol subcarriers in a plurality of frequency channels, and a subset of said subcarriers are pilot subcarriers, the method comprising:
receiving an OFDM encoded signal over a wireless channel;
forming an estimate of the wireless channel, based on received pilot subcarriers;
determining whether properties of the estimated wireless channel are indicative of a relatively high rate of change of the wireless channel or a relatively low rate of change of the wireless channel;
processing the received signal based on the properties of the estimated wireless channel.

2. A method as claimed in claim 1, comprising:
if the properties of the estimated wireless channel are indicative of a relatively high rate of change of the wireless channel, forming an estimate of a frequency response of the wireless channel based on a first channel estimation algorithm, and
if the properties of the estimated wireless channel are indicative of a relatively low rate of change of the wireless channel, forming an estimate of a frequency response of the wireless channel based on a second channel estimation algorithm.

3. A method as claimed in claim 1, comprising if the properties of the estimated wireless channel are indicative of a relatively high rate of change of the wireless channel, forming an estimate of a frequency response of the wireless channel based on the pilot subcarriers of a current symbol only.

4. A method as claimed in claim 1, comprising if the properties of the estimated wireless channel are indicative of a relatively low rate of change of the wireless channel, forming an estimate of a frequency response of the wireless channel based on the pilot subcarriers of the current symbol and based on the pilot subcarriers of at least one other symbol.

5. A method as claimed in claim 3, comprising processing the received signal based on the estimated frequency response of the wireless channel.

6. A method as claimed in claim 1, wherein the step of determining whether properties of the estimated wireless channel are indicative of a relatively high rate of change of the wireless channel comprises determining a correlation between successive channel estimates.

7. A method as claimed in claim 6, wherein the step of determining a correlation between successive channel estimates further comprises normalizing said correlation with respect to a current channel estimate.

8. A method as claimed in claim 1, wherein the step of determining whether properties of the estimated wireless channel are indicative of a relatively high rate of change of the wireless channel comprises determining a power of a time derivative of a channel estimate.

9. A receiver, for use in an OFDM communications system, wherein OFDM encoded digital signals are transmitted over a wireless channel as data symbol subcarriers in a plurality of frequency channels, and a subset of said subcarriers are pilot subcarriers, wherein the receiver comprises a processor for:
forming an estimate of the wireless channel, based on received pilot subcarriers;
determining whether properties of the estimated wireless channel are indicative of a relatively high rate of change of the wireless channel or a relatively low rate of change of the wireless channel; and
processing the received signal based on the properties of the estimated wireless channel.

10. A receiver as claimed in claim 9, wherein:
if the processor determines that the properties of the estimated wireless channel are indicative of a relatively high rate of change of the wireless channel, the processor forms an estimate of a frequency response of the wireless channel based on a first channel estimation algorithm, and
if the processor determines that the properties of the estimated wireless channel are indicative of a relatively low rate of change of the wireless channel, the processor forms an estimate of a frequency response of the wireless channel based on a second channel estimation algorithm.

11. A receiver as claimed in claim 9, wherein:
if the processor determines that the properties of the estimated wireless channel are indicative of a relatively high rate of change of the wireless channel, the processor forms an estimate of a frequency response of the wireless channel based on the pilot subcarriers of a current symbol only.

12. A receiver as claimed in claim 9, wherein:
if the processor determines that the properties of the estimated wireless channel are indicative of a relatively low rate of change of the wireless channel, the processor forms an estimate of a frequency response of the wireless channel based on the pilot subcarriers of the current symbol and based on the pilot subcarriers of at least one other symbol.

13. A receiver as claimed in claim 11, wherein the processor is further adapted for processing the received signal based on the estimated frequency response of the wireless channel.

14. A receiver as claimed in claim 9, wherein the processor is adapted for determining whether properties of the estimated wireless channel are indicative of a relatively high rate of change of the wireless channel by determining a correlation between successive channel estimates.

15. A receiver as claimed in claim 14, wherein the processor is adapted for determining a correlation between successive channel estimates by normalizing said correlation with respect to a current channel estimate.

16. A receiver as claimed in claim 9, wherein the processor is adapted for determining whether properties of the estimated wireless channel are indicative of a relatively high rate of change of the wireless channel by determining a power of a time derivative of a channel estimate.
